(19) United States
(12) Patent Application Publication
(10) Pub. No.: US 2011/0161690 A1
(43) Pub. Date: Jun. 30, 2011

(54) VOLTAGE SCALING SYSTEMS

(75) Inventors: Tay-Jyi LIN, Daliao Township (TW); Pi-Cheng HSIAO, Taichung City (TW)

(73) Assignee: INDUSTRIAL TECHNOLOGY RESEARCH INSTITUTE, Hsinchu (TW)

(21) Appl. No.: 12/972,026

(22) Filed: Dec. 17, 2010

(30) Foreign Application Priority Data
Dec. 29, 2009 (TW) 098145477

(51) Int. Cl. G06F 1/26

(52) U.S. Cl. 713/300

(57) ABSTRACT

A voltage scaling system is provided and includes a processor, a latency predictor, a controller, and a voltage supplier. The processor performs functions and includes a function unit with variable-latency. The function unit is divided into several power domains. When the processor performs the functions, the function unit generates a latency signal according to a current circuit execution speed. The latency predictor predicts performance of the processor according to the received latency signal to generate a predication signal. The controller compares a value of the predication signal with at least one reference value. The controller generates control signals according to the comparison result. The voltage supplier couples to a first voltage source providing a high voltage and a second voltage source providing a low voltage. The voltage supplier is switched to provide the high or low voltage to the power domains according to the control signals, respectively.

### CROSS REFERENCE TO RELATED APPLICATIONS

This application claims the benefit of Taiwan application Serial No. 98145477 filed Dec. 29, 2009, the subject matter of which is incorporated herein by reference.

### TECHNICAL FIELD

The technical field relates to a voltage scaling system.

### BACKGROUND

Currently, portable electronic devices provide various functions, such as communication, image display, and audio play, and battery usage is one of the most important concerns. Since the variations of computation requirements in different applications are large, many electronic devices use dynamic voltage scaling (DVS) techniques. In the DVS technique, a system of an electronic device scales operating voltages according to a requested performance, so that the power consumption can be minimized while the requested performance can be satisfied. In the so-called adaptive voltage scaling (AVS) systems, system performance of electronic devices is dynamically monitored, a feedback control circuit calculates a system voltage, and an adjustable power converter scales an operating voltage accordingly.

FIG. 1 shows a conventional AVS system. Referring to FIG. 1, a conventional AVS system comprises a processor 10, a performance monitor 11, a controller 12, and a power converter 13. The performance monitor 11 monitors the performance when the processor 12 operates, and generates a monitoring signal S11 sent to the controller 12. The controller 12 compares the value of the monitoring signal S11 and the performance target value S_{target} and generates a control signal S12 according to the comparison result. The power converter 14 receives an input voltage Vin and performs voltage conversion to the input voltage Vin according to the control signal S12. The converted voltage serves as an operating voltage VDD, which is provided to the processor 10 and the performance monitor 11.

In some conventional operation, the performance monitor 11 predicts the circuit latency of the processor 10 at different operating voltages VDD with a delay line to serve as a basis for scaling operating voltage by the controller 12 and the power converter 13. However, there is often a mismatch between the predicted latency and the real latency of the critical path. Therefore, the control machine based on the delay line has to set a safe margin to prevent the system circuit from failure caused by the variation of the circuit latency when unexpected situations occur.

In some other conventional operation, the performance monitor 11 mirrors the critical path of the processor 10 for monitoring, and the mirrored critical path serves as the basis for scaling operating voltage by the controller 12 and the power converter 13. However, due to process variations and varying operating environments, the critical path of the processor 10 may be changed, so that it is difficult to choose the critical path in advance. Meanwhile, when there are several possible critical paths to be copied, circuitry becomes more complex, resulting in increased power consumption.

Moreover, the power converter 13 used by the AVS system 1 in FIG. 1 is implemented with a DC-DC converter or a power management IC (PMIC). However, a PMIC only provides a limited number of adjustable output voltages. When a system uses a plurality of processors 10 (such a multi-core processor system), a plurality of voltage sources are required to provide adjustable voltages. Thus, the plurality of PMICs and corresponding power inputs/outputs (I/Os) result in increased costs.

Thus, it is desired to provide a voltage scaling system which can accomplish adaptive voltage scaling with a more simplified circuitry design.

### BRIEF SUMMARY OF THE DISCLOSURE

An exemplary embodiment of a voltage scaling system comprises a processor, a latency predictor, a controller, and a voltage supplier. The processor performs a plurality of functions and comprises a function unit with variable-latency. The function unit is divided into a plurality of power domains. When the processor performs the functions, the function unit generates a latency signal according to a current circuit execution speed. The latency predictor receives the latency signal and predicts performance of the processor according to the latency signal to generate a predication signal. The controller receives the predication signal and compares a value of the predication signal with at least one reference value. The controller generates a plurality of control signals according to the comparison result. The voltage supplier couples to a first voltage source providing a high voltage and a second voltage source providing a low voltage. The voltage supplier is switched to provide the high voltage or the low voltage to the power domains according to the control signals, respectively.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a conventional AVS system;

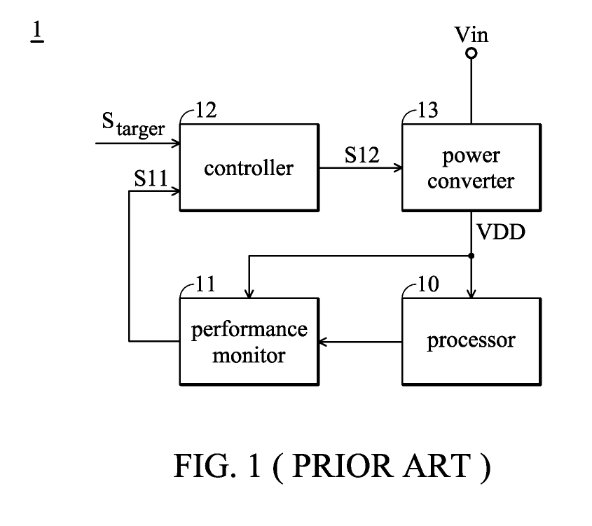

FIG. 2a shows an exemplary embodiment of a voltage scaling system;

FIG. 2b shows another exemplary embodiment of a voltage scaling system;

FIG. 3 shows an exemplary embodiment of the latency predictor in FIG. 2a;

FIG. 4a shows an exemplary embodiment of the controller in FIG. 2a;

FIG. 4b shows an exemplary embodiment of the controller in FIG. 2b; and

FIG. 5 shows an exemplary embodiment of the voltage supplier in FIG. 2a.

### DETAILED DESCRIPTION OF THE DISCLOSURE

The following description is of the best-contemplated mode of carrying out the disclosure. This description is made for the purpose of illustrating the general principles of the invention and should not be taken in a limiting sense. The scope of the invention is best determined by reference to the appended claims.

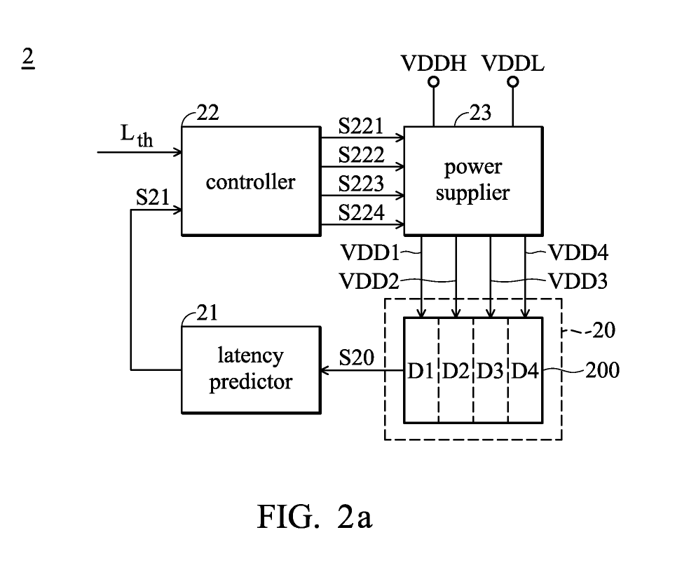

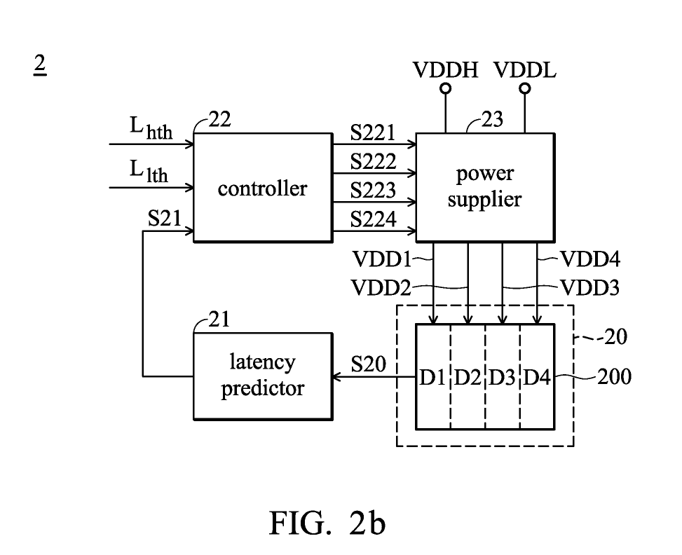

Voltage scaling systems are provided. In an exemplary embodiment of a voltage scaling system in FIG. 2a, a voltage scaling system 2 can provide operating voltages to power domains of a function unit in a processor according to latency control of the function unit. Referring to FIG. 2a, the voltage scaling system 2 comprises a processor 20, a latency predictor 21, a controller 22, and a power supplier 23. The processor 20 can perform several functions and comprises a function unit 200 with variable latency. The variable-latency function unit 200 is divided into a plurality of power domains. In the embodiment in FIG. 2a, the variable-latency function unit 200 divided into four power domains D1˜D4 is given as an example. The voltage supplier 23 provides four operating voltages VDD1˜VDD4 to the four power domains in the variable-latency function unit 200, respectively. When the processor 20 performs the functions, the variable-latency function unit 200 changes the latency according to the current circuit execution speed and generates a latency signal S20. The circuit execution speed may be changed according to different operating voltages or different values to be processed. For example, when the variable-latency function unit 200 performs the functions with values by a lower circuit execution speed, the variable-latency function unit 200 changes the operation of a single clock cycle to two or more clock cycles, or, for example, the variable-latency function unit 200 changes the latency with the variation of the operating voltages VDD1˜VDD4 provided to the power domains D1˜D4. In the embodiment, latency indicates an amount of time which is required for the variable-latency function unit 200 to finish the functions.

The variable-latency function unit 200 transmits the latency signal S20 to the latency predictor 21. The latency predictor 21 receives the latency signal S20 and predicts the current performance of the processor 20 according to the latency signal S20. The latency predictor 21 further generates a prediction signal S21 according to the predicted performance. Thus, the prediction signal S21 indicates an amount of time which is required for the processor 20 to finish the functions. The controller 22 receives the prediction signal S21 and compares the value of the prediction signal S21 with at least one reference value. The controller 22 generates a plurality of control signals according to the comparison result. In the embodiment of FIG. 2a, one reference value Lₜₕ provided to the controller 22 is given as an example. Moreover, in the embodiment, since four power domains D1˜D4 in the variable-latency function unit 200 are given as an example, the controller 22 also generates four control signals S221˜S224. Referring to FIG. 2a, the voltage supplier 23 couples to a voltage source VDDH for receiving a high voltage and coupled to a voltage source VDDL for receiving a low voltage. The voltage supplier 23 is switched to provide the high voltage or the low voltage to the four power domains D1˜D4 in the variable-latency function unit 200 according to the control signals S221˜S224, respectively. For example, the voltage supplier 23 is switched to provide the high voltage or the low voltage to serve as the operating voltage VDD1 of the power domain D1 according to the control signal S221, the voltage supplier 23 is switched to provide the high voltage or the low voltage to serve as the operating voltage VDD2 of the power domain D2 according to the control signal S222, and so on.

As described above, the voltage scaling system 2 of the embodiment can predict current performance according to the latency signal and further dynamically scale the operating voltages provided to the power domains for accomplishing adaptive voltage scaling. The voltage scaling system 2 does not request a latency safe margin and has low circuitry complexity and low power consumption.

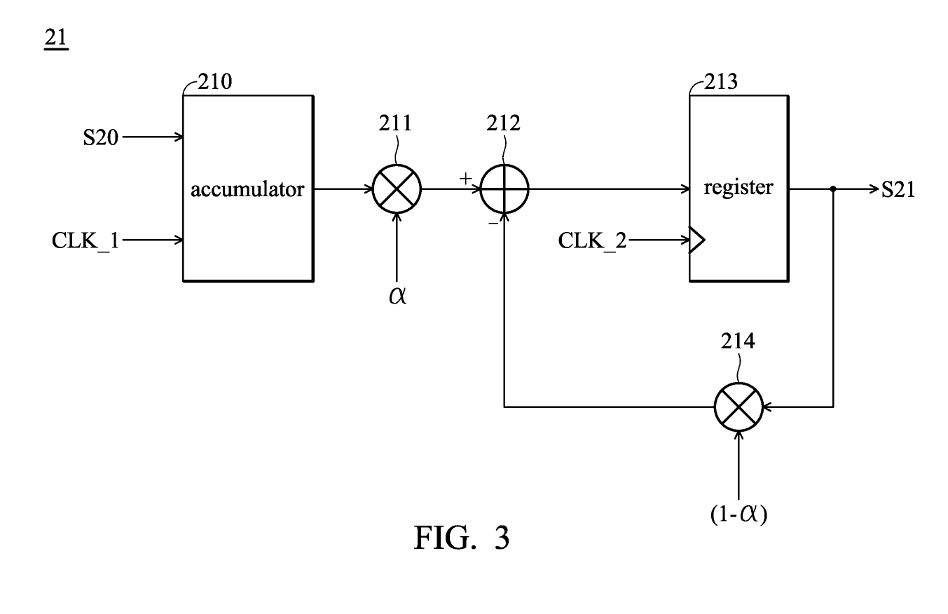

FIG. 3 shows an exemplary embodiment of the latency predictor 21. Referring to FIG. 3, the latency predictor 21 has a single-pole infinite impulse response (IIR) machine. The latency predictor 21 comprises an accumulator 210, multipliers 211 and 214, an adder 212, and a register 213. The latency predictor 21 obtains the moving average of the latency signal S20 according to the latency signal S20 and clock signals CLK_1 and CLK_2 to serve as the prediction signal S21. Since one skilled in the art knows about the operation of the IIR machine composed of the accumulator 210, the multipliers 211 and 214, the adder 212, and the register 213, the related description herein is omitted. The IIR machine in FIG. 3 is an example. The latency predictor 21 can be implemented by other machines. For example, the sum of the latency in a fixed time interval is calculated by a calculator and an accumulator to serve as the average of the latency.

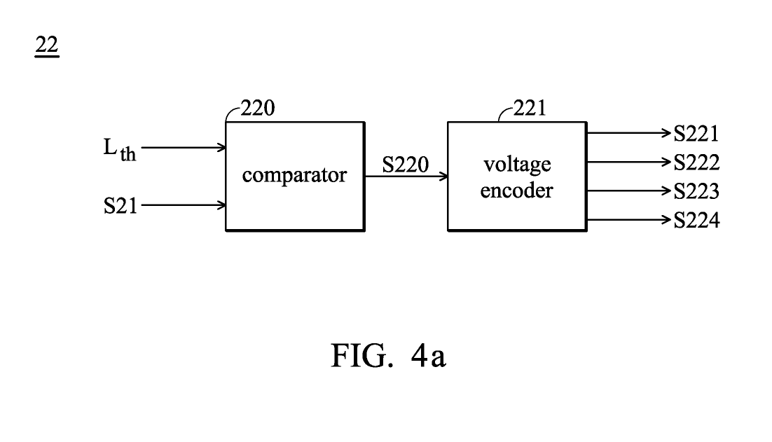

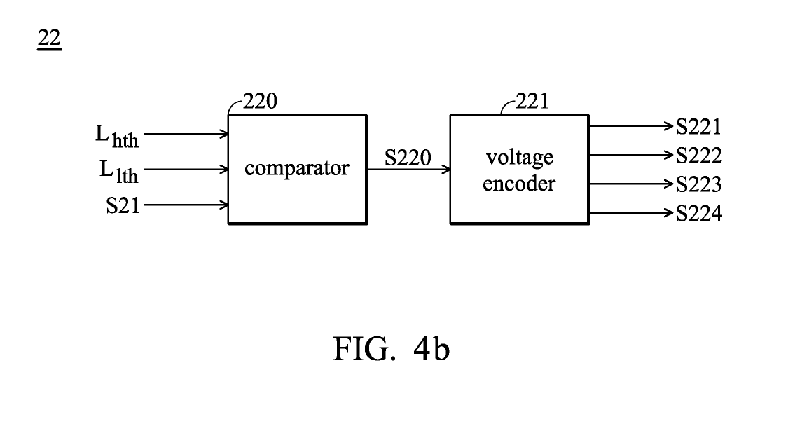

FIG. 4a shows an exemplary embodiment of the controller 22. Referring to FIG. 4a, the controller 22 comprises a comparator 220 and a voltage encoder 221. The comparator 220 comprises the value of the prediction signal S21 and the reference value Lₜₕ and generates a result signal S220 according to the comparison result. The voltage encoder 221 receives the result signal S220 and generates the control signals S221˜S224 with a specific formation according to the result signal S220. In the embodiment, the specific formation is thermal code formation, which is an example for description. The voltage encoder 221 can also determine power switching priority according to the dividing manner of the power domains and generate a control code signal.

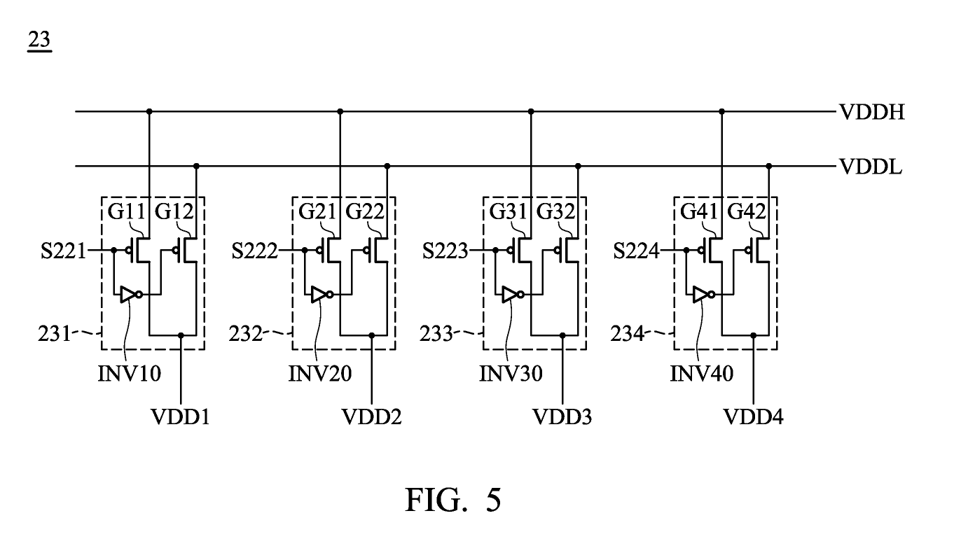

FIG. 5 shows an exemplary embodiment of the voltage supplier 23. Referring to FIG. 5, the voltage supplier 23 comprises four switching units 231˜234 for providing the operating voltages VDD1˜VDD4 to the four power domains D1˜D4 of the variable-latency function unit 200, respectively. Each of the switching units 231˜234 comprises two power gating cells coupled to the high voltage source VDDH and the low voltage source VDDL, respectively. Each of the control signals S221˜S224 controls one power gating cell in the corresponding switching unit and controls the other power gate cell therein by using an inverter. Referring to FIG. 5, the switching unit 231 comprises two power gating cells G11 and G12, and the control signal S221 controls the power gating cell G11 and controls the power gate cell G12 by using an inverter INV10. The switching unit 232 comprises two power gating cells G21 and G22, and the control signal S222 controls the power gating cell G21 and controls the power gate cell G22 by using an inverter INV20. The switching unit 233 comprises two power gating cells G31 and G32, and the control signal S223 controls the power gating cell G31 and controls the power gate cell G32 by using an inverter INV30. The switching unit 234 comprises two power gating cells G41 and G42, and the control signal S224 controls the power gating cell G41 and controls the power gate cell G42 by using an inverter INV40. By using the two power gate cells in each switching unit, the switching units 231˜234 are switched to provide a high voltage or a low voltage to serve as the operating voltages of corresponding power domains. For example, when the control signals S221˜S224 indicate a digital logic “1010”, the switching unit 231 couples the power domain D1 to the low voltage source VDDL, the switching unit 232 couples the power domain D2 to the high voltage source VDDH, and so on.

In the following, the operation of the controller 22 and the supplier 23 will be described with reference to FIGS. 4a and 5. FIG. 4a shows an exemplary embodiment in which the comparator 220 receives one reference value Lₜₕ. When the value of the prediction signal S21 is greater than the reference value Lₜₕ, the predicted current latency of the processor 20 exceeds a defined target. The control signals S221˜S224 which are generated by the voltage encoder 221 according to the comparison result (that is the result signal S220) control the switching units 231˜234 to increase the number of switching units coupling the high voltage source VDDH to the power domains. In other words, when the value of the prediction signal S21 is greater than the reference value Lₜₕ, the number of power domains using the high voltage to serve as the respective operating voltages is increased. Contrarily, when the value of the prediction signal S21 is less than the reference value Lₜₕ, the control signals S221˜S224 which are generated by the voltage encoder 221 according to the comparison result (that is the result signal S220) control the switching units 231˜234 to decrease the number of power domains using the high voltage to serve as the respective operating voltages.

In the embodiment of FIGS. 2a and 4, the comparator 220 of the controller 22 receiving one reference value Lₜₕ is given as an example for description. In another embodiment, the comparator 220 of the controller 22 can receive two reference values Lₕₜₕ and Lₗₜₕ, wherein the reference value Lₕₜₕ is greater than the reference value Lᵢₜₕ. The controller 22 receives the prediction signal S21 and compares the value of the prediction signal S21 with the reference values Lₕₜₕ and Lₗₜₕ. The controller 22 generates the control signals S221˜S224, which is transmitted to the voltage supplier 23 according to the comparison result.

FIG. 4b shows an exemplary embodiment of the controller 22 in FIG. 2b. Referring to FIG. 4b, the comparator 220 receives the prediction signal S21 and the reference values Lₕₜₕ and Lₗₜₕ and compares the value of the prediction signal S21 with the reference values Lₕₜₕ and Lₗₜₕ. The comparator 220 generates the result signal S220 according to the comparison result. The voltage encoder 221 receives the result signal S220 and generates the control signals S221˜S224 according to the result signal S220.

When the value of the prediction signal S21 is greater than the reference value Lₕₜₕ, the control signals S221˜S224, which are generated by the voltage encoder 221 according to the comparison result (that is the result signal S220), control the switching units 231˜234 to increase the number of switching units to provide the high voltage of the high voltage source VDDH to the power domains to serve as the respective operating voltages. In other words, when the value of the prediction signal S21 is greater than the reference value L_{hth,} the number of power domains using the high voltage to serve as the respective operating voltages is increased. Contrarily, when the value of the prediction signal S21 is less than the reference value Lₗₜₕ, the number of power domains using the high voltage to serve as the respective operating voltages is decreased. When the value of the prediction signal S21 is between the reference values Lₕₜₕ and Lₗₜₕ, the switching units 213˜234 do not perform the switching operation between the high voltage source VDDH and the low voltage source VDDL. That is, the number of power domains receiving the high voltage is not changed.

According to the above embodiments, the power domains D1′˜D4 of the variable-latency function unit 200 receive a high voltage or a low voltage by using the switching units 231˜234, respectively. Thus, for the variable-latency function unit 200, multi-step voltage scaling can be accomplished by individually controlling the operating voltages of the power domains. Moreover, the voltage supplier 23 can be implemented by simple switching units and operations without power management ICs (PMICs) to accomplish voltage scaling, decreasing system costs.

With system requirements, the control signals S221˜S223 can be implemented by a digital signal with four bits, wherein the four bits represent the control signals S221˜S223, respectively.

While the disclosure has been described by way of example and in terms of the embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voltage scaling system comprising:
a processor, performing a plurality of functions and comprising a function unit with variable latency, wherein the function unit is divided into a plurality of power domains, and when the processor performs the functions, the function unit generates a latency signal according to a current circuit execution speed;
a latency predictor, receiving the latency signal and predicting performance of the processor according to the latency signal to generate a predication signal;
a controller, receiving the predication signal, comparing a value of the predication signal with at least one reference value, and generating a plurality of control signals according to the comparison result; and
a voltage supplier coupling to a first voltage source providing a high voltage and a second voltage source providing a low voltage;
wherein the voltage supplier is switched to provide the high voltage or the low voltage to the power domains according to the control signals, respectively.

2. The voltage scaling system as claimed in claim 1, wherein the predication signal indicates an amount of time which is required for the function unit to finish functions.

3. The voltage scaling system as claimed in claim 1, wherein the voltage supplier comprises:
a plurality of switching units receiving the control signals, respectively,
wherein each of the switching units is coupled to the first voltage source and the second voltage source and provides the high voltage or the low voltage to the corresponding power domain according to the corresponding control signal.

4. The voltage scaling system as claimed in claim 3, wherein the controller comprises:
a comparator, receiving the predication signal and the at least one reference value, comparing the value of the predication signal with the at least one reference value, and generating a result signal according to the comparison result; and
a voltage encoder, receiving the result signal and generating the control signals according to the result signal.

5. The voltage scaling system as claimed in claim 4, wherein when the value of the predication signal is greater than the at least one reference value, the number of switching units providing the high voltage according to the control signals is increased.

6. The voltage scaling system as claimed in claim 4, wherein when the value of the predication signal is less than the at least one reference value, the number of switching units providing the high voltage according to the control signals is decreased.

7. The voltage scaling system as claimed in claim 3, wherein each of the switching units comprises a first power gating cell, a second power gating cell, and an inverter, the first and second power gating cells couple to the first and second voltage sources, respectively, and each of the switching units receives the corresponding control signal to control the first power gating cell and further to control the second power gating cell by using the inverter.

8. The voltage scaling system as claimed in claim 1, wherein the controller comprises:
a comparator, receiving the predication signal and the at least one reference value, comparing the value of the predication signal with the at least one reference value, and generating a result signal according to the comparison result; and
a voltage encoder, receiving the result signal and generating the control signals according to the result signal.

9. The voltage scaling system as claimed in claim 8, wherein when the value of the predication signal is greater than the at least one reference value, the number of power domains receiving the high voltage according to the control signals is increased.

10. The voltage scaling system as claimed in claim 8, wherein when the value of the predication signal is less than the at least one reference value, the number of power domains receiving the high voltage according to the control signals is decreased.
